(19) United States
(12) Patent Application Publication
(10) Pub. No.: US 2026/0241841 A1
(43) Pub. Date: Aug. 20, 2026

(54) SEAT BASE WITH MOVABLE FOOT

(71) Applicant: Dorel Juvenile Group, Inc., Foxboro, MA (US)

(72) Inventors: Conor Newton DAVIES, Foxboro, MA (US); Jacob Sebastian BAILEY, Foxboro, MA (US)

(21) Appl. No.: 19/540,948

(22) Filed: Feb. 16, 2026

Related U.S. Application Data
(60) Provisional application No. 63/759,394, filed on Feb. 17, 2025.

(51) Int. Cl. B60N 2/28; B60N 2/30

(52) U.S. Cl. CPC B60N 2/2863; B60N 2/2821; B60N 2/3065

(57) ABSTRACT

A child restraint includes a juvenile seat adapted to hold a child for transportation in a vehicle, and a seat base configured to support the juvenile seat and configured to attach to an underlying vehicle seat. The seat base includes a seat-base foundation and an angle-adjustment foot configured to control a tilted orientation of the seat base and the juvenile seat relative to the vehicle seat.

### PRIORITY CLAIM

This application claims priority under 35 U.S.C. § 119(e) to U.S. Provisional Patent Application No. 63/759,394, filed February 17, 2025, which is expressly incorporated by reference herein in its entirety.

### BACKGROUND

The present disclosure relates to a child safety device, and particularly to a child restraint. More particularly, the present disclosure relates to a child car seat configured to attach to an underlying vehicle seat.

### SUMMARY

According to the present disclosure, a child restraint includes a juvenile seat configured to support and restrain a child for transportation in a vehicle, and a seat base configured to support the juvenile seat and configured to attach to an underlying vehicle seat. The seat base includes a seat-base foundation coupled to the juvenile seat, a foot catch coupled to the seat-base foundation in a fixed position relative to the seat-base foundation, and an angle-adjustment foot coupled to the seat-base foundation. The angle-adjustment foot is movable relative to the seat-base foundation and the foot catch to adjust a tilted orientation of the seat base relative to the vehicle seat.

In illustrative embodiments, the angle-adjustment foot is mounted to the seat-base foundation for movement relative to the seat-base foundation and the foot catch between a locked position and an unlocked position. In the locked position, the angle-adjustment foot is engaged with the foot catch to block movement of the angle adjustment foot relative to the seat-base foundation. In the unlocked position, the angle-adjustment foot is at least partially separated from the foot catch to free the angle-adjustment foot for pivotable movement about a pivot axis relative to the seat-base foundation and the foot catch to a plurality of angular orientations relative to the seat-base foundation. Each angular orientation corresponds with a different tilted orientation of the seat base relative to the vehicle seat.

In illustrative embodiments, the angle-adjustment foot includes a foot body, a foot axle extending between and interconnecting the foot body and the seat-base foundation to mount the angle-adjustment foot to the seat-base foundation, and a foot lock coupled to the foot body for movement therewith. The foot lock is configured to engage selectively with the foot catch in the locked position to block pivotable movement of the angle-adjustment foot about the pivot axis relative to the seat-base foundation.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective and diagrammatic view of a child restraint, in accordance with the present disclosure, including a juvenile seat configured to support and restrain a child for transportation in a vehicle and a seat base configured to attach to an underlying vehicle seat, the seat base including a seat-base foundation coupled to the juvenile seat, a foot catch coupled to the seat-base foundation in a fixed position relative to the seat-base foundation, and an angle-adjustment foot coupled to the seat-base foundation;

FIG. 2 is a perspective and diagrammatic view of the child restraint of FIG. 1 showing the angle-adjustment foot deployed to engage with the underlying vehicle seat and support the child restraint in one of a plurality of tilted orientations established by the angle-adjustment foot;

FIG. 3 is an exploded assembly view the seat base showing, from top to bottom, the seat-base foundation, first and second opposing foot catches configured to be mounted to the seat base foundation, and the angle-adjustment foot configured to be mounted to the seat-base foundation and to engage selectively with the first and second foot catches to block movement of the angle-adjustment foot relative to the seat-base foundation;

FIG. 4 is an enlarged perspective view of portions of the seat base with the seat-base foundation shown with transparency to show the foot catch mounted to an interior surface of the seat-base foundation at least partially defining a foot-receiving space and the angle-adjustment foot including a foot body configured to engage with the vehicle seat, a foot axle coupled to the foot body and coupled to the seat base foundation, and a foot lock configured to selectively engage with the foot catch to block movement of the angle-adjustment foot relative to the seat-base foundation;

FIG. 5A is a side elevation view of a portion of the seat base showing the angle-adjustment foot in an unlocked position where the angle-adjustment foot is free to pivot about a pivot axis relative to the seat-base foundation to adjust the tilted orientation of the child restraint and showing the angle-adjustment foot in a fully extended position;

FIG. 5B is a side elevation view of the portion of the seat base of FIG. 5A showing the angle-adjustment foot pivoted about the pivot axis to an intermediate position;

FIG. 5C is a side elevation view of the portion of the seat base of FIG. 5A showing the angle-adjustment foot pivoted about the pivot axis to a stowed position;

FIG. 6A is a side elevation view of a portion of the seat base showing the angle-adjustment foot in a locked position engaged with the foot catch and in the stowed position;

FIG. 6B is a side elevation view of the portion of the seat base of FIG. 6A showing the angle-adjustment foot in the locked position and in a first angular orientation to position a first support surface to interface with the vehicle seat and space a portion of the seat base a first distance from the vehicle seat;

FIG. 6C is a side elevation view of the portion of the seat base of FIG. 6A showing the angle-adjustment foot in the locked position and in a second angular orientation to position a second support surface to interface with the vehicle seat and space a portion of the seat base a second distance from the vehicle seat greater than the first distance; and

FIG. 6D is a side elevation view of the portion of the seat base of FIG. 6A showing the angle-adjustment foot in the locked position and in a third angular orientation to position a third support surface to interface with the vehicle seat and space a portion of the seat base a third distance from the vehicle seat greater than the first and second distances.

### DETAILED DESCRIPTION

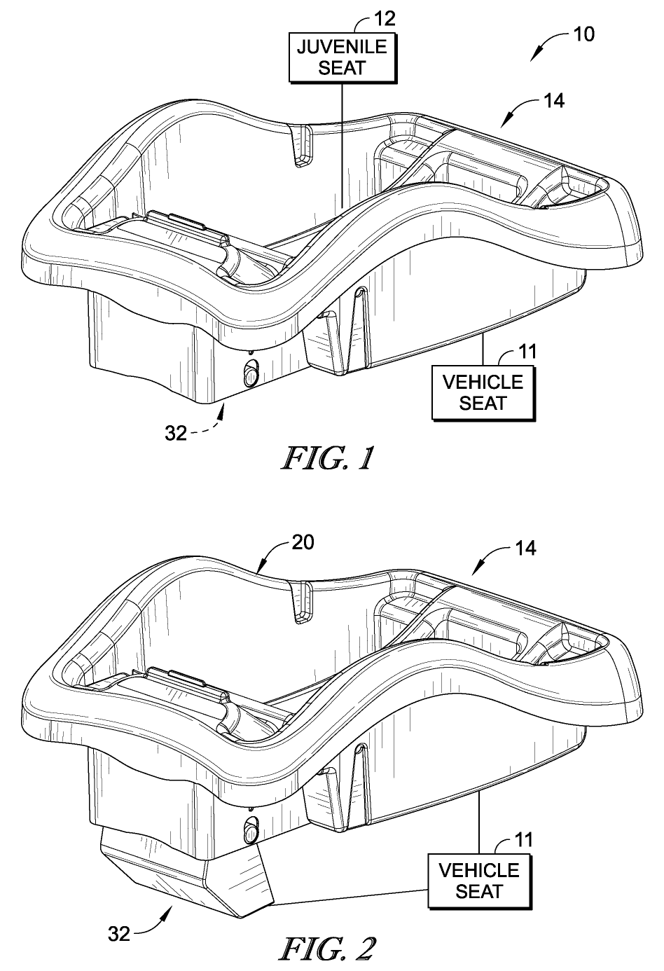

A child restraint 10 includes a juvenile seat 12 and a seat base 14. The juvenile seat 12 is configured to support and restrain a child for transportation in a vehicle. The seat base 14 is configured to support the juvenile seat 12 and is configured to attach to an underlying vehicle seat 11 as suggested in FIG. 1. The juvenile seat 12 and the seat base 14 may be fixed to one another or separable from one another.

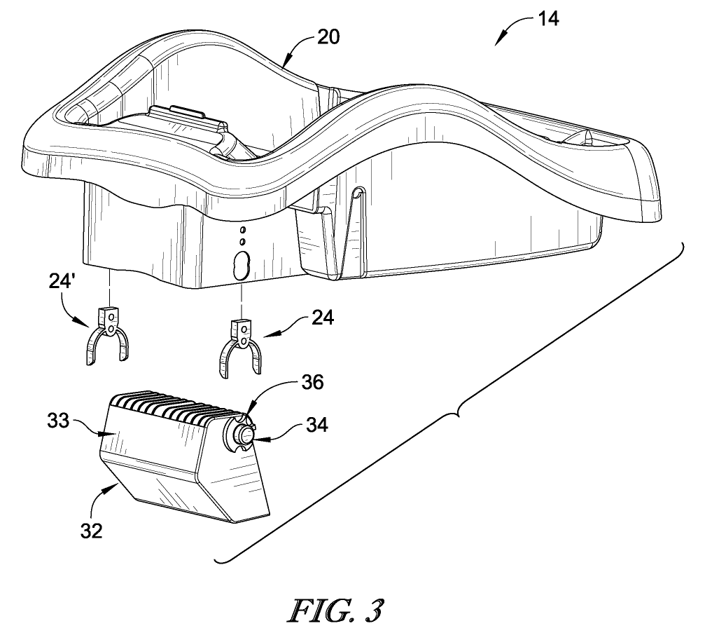

The seat base 14 includes a seat-base foundation 20 coupled to the juvenile seat 12, a foot catch 24 coupled to the seat-base foundation 20 in a fixed position relative to the seat-base foundation 20, and an angle-adjustment foot 32 coupled to the seat-base foundation 20. The seat-base foundation 20 is configured to couple to the juvenile seat 12 to support the juvenile seat 12. The foot catch 24 is configured to block movement of the angle-adjustment foot 32 relative to the seat-base foundation 20. The angle-adjustment foot 32 is movable relative to the seat-base foundation 20 to extend and retract from a foot-receiving space 31 formed in the seat-base foundation 20 to adjust a tilted orientation of juvenile seat 12 and the seat base 14 relative to the vehicle seat 11 as shown in FIG. 2. The angle-adjustment foot 32 is mounted to a rear end20R of the seat-base foundation 20 and increases and decreases a distance of the rear end 20R from the underlying vehicle seat 11 to vary the tilted orientation of the juvenile seat 12 relative to the vehicle seat 11.

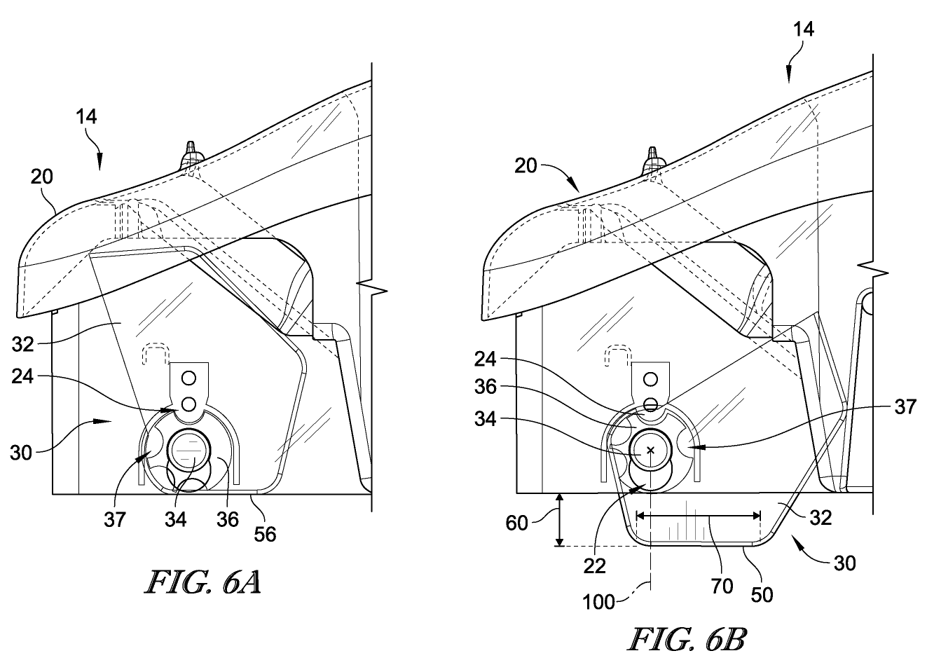

The angle-adjustment foot 32 is movable relative to the seat-base foundation 20 and the foot catch 24 between a locked position, as shown in FIGS. 1, 2, and 4, and an unlocked position, as shown in FIGS. 5A-5C. In the locked position, the angle-adjustment foot 32 engages with the foot catch 24 to block movement of the angle adjustment foot 32 relative to the seat-base foundation 20. In the unlocked position, the angle-adjustment foot 32 is at least partially separated from the foot catch 24 to free the angle-adjustment foot 32 for pivotable movement about a pivot axis 40 relative to the seat-base foundation 20 and the foot catch 24 to a plurality of angular orientations relative to the seat-base foundation 20. After a user pivots the angle-adjustment foot 32 to a selected angular orientation, the angle-adjustment foot 32 may be moved back to the locked position to fix the angle-adjustment foot 32 in the selected angular orientation. Each angular orientation corresponds with a different tilted orientation of the seat base 14 relative to the vehicle seat 11.

The angle-adjustment foot 32 includes a foot body 33, a foot axle 34, and a foot lock 36 as shown in FIGS. 2-4. The foot body 33 is configured to engage the underlying vehicle seat 11 to support the seat base 14 in a tilted orientation. The foot axle 34 extends between and interconnects the foot body 33 and the seat-base foundation 20 to mount the angle-adjustment foot 32 to the seat-base foundation 20. The foot lock 36 is coupled to the foot body 33 for movement therewith and is configured to engage selectively with the foot catch 24 in the locked position to block pivotable movement of the angle-adjustment foot 32 about the pivot axis 40 relative to the seat-base foundation 20.

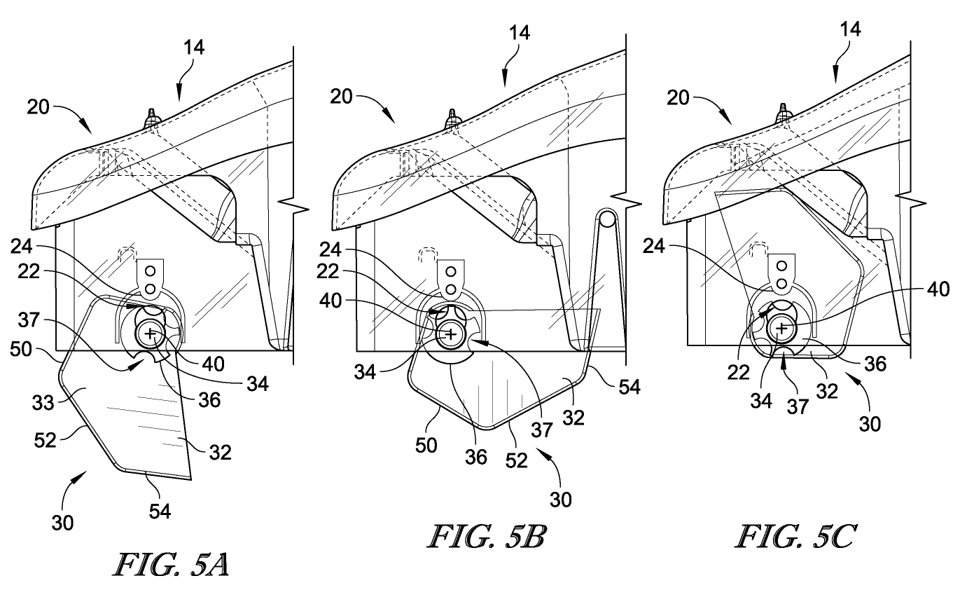

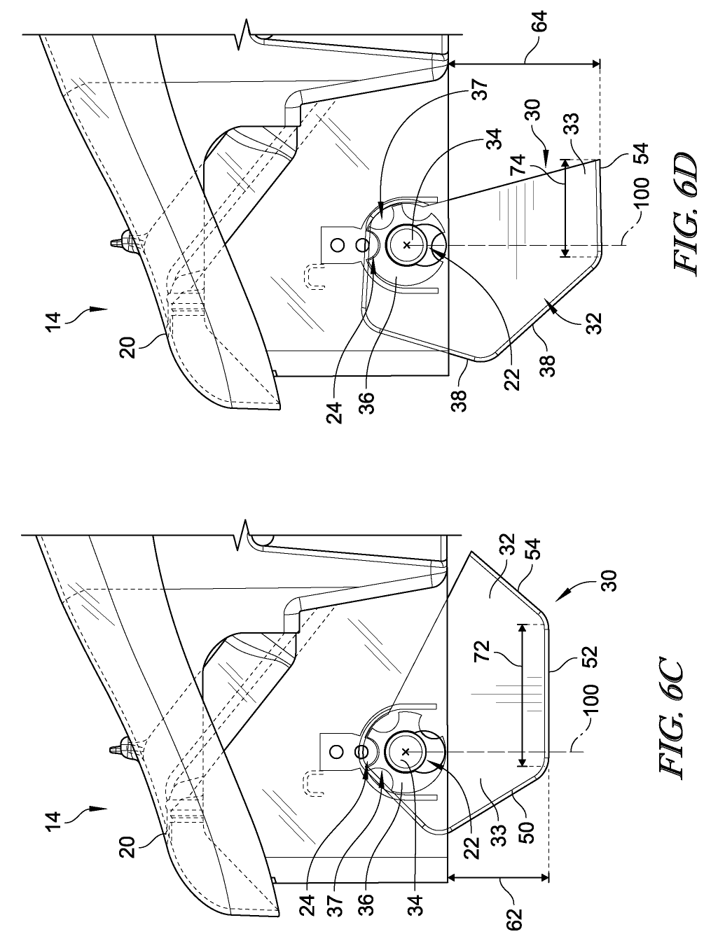

The foot body 33 includes a plurality of support surfaces 38 each arranged along a respective plane as shown in FIGS. 4 and 6A-6D. Each support surface 38 is configured to interface with the underlying vehicle seat 11 when the angle-adjustment foot 32 is in a corresponding angular orientation.

The plurality of support surfaces 38 includes a first support surface 50, a second support surface 52, and a third support surface 54. The first support surface 50 is configured to interface with the underlying vehicle seat 11 when the angle-adjustment foot 32 is in a first angular orientation to space a portion of the seat-base foundation 20 a first distance 60 from the underlying vehicle seat 11 as shown in FIG. 6B. The second support surface 52 is coupled to the first support surface 50 and is configured to interface with the underlying vehicle seat 11 when the angle-adjustment foot 32 is in a second angular orientation to space the portion of the seat-base foundation 20 a second distance 62 from the underlying vehicle seat 11 greater than the first distance 60 as shown in FIG. 6C. The third support surface 54 is coupled to the second support surface 52 and is configured to interface with the underlying vehicle seat 11 when the angle-adjustment foot 32 is in a third angular orientation to space the portion of the seat-base foundation 20 a third distance 64 from the underlying vehicle seat 11 greater than the second distance 62 as shown in FIG. 6D.

The third angular orientation of the adjustment foot 32 represents a fully extended position of the angle-adjustment foot 32 as shown in FIG. 6D. The angle-adjustment foot 32 may further include a fourth support surface 56 coupled to the first support surface 50 and configured to interface with the underlying vehicle seat 11 in a fourth angular orientation corresponding with a fully-retracted or stowed position of the angle-adjustment foot 32 as shown in FIG. 6A. The fourth support surface 56 is aligned with a lower surface of the seat-base foundation 20 in a vertical direction when the angle-adjustment foot 32 is in the fourth angular orientation. In other words, the angle-adjustment foot 32 may cooperate with the seat-base foundation 20 to engage and support the seat base 14 on the underlying vehicle seat 11 in the fourth angular orientation. In some embodiments, the angle-adjustment foot 32 may include additional support surfaces and corresponding angular orientations and spacing distances to provide more tilted orientations for the seat base 14.

The first support surface 50 has a first length 70 as shown in FIG. 6B. The second support surface 52 has a second length 72 greater than the first length 70 as shown in FIG. 6C. The third support surface 54 has a third length 74 less than the first and second lengths 70, 72 as shown in FIG. 6D.

Each support surface 38 intersects with a perpendicular plane 100 passing through the pivot axis 40 at a center of the foot axle 34 when each support surface 38 interfaces with the underlying vehicle seat 11. The perpendicular plane 100 intersects each support surface 38 interfacing with the underlying vehicle seat 11 at a location between a midway point and a rearmost point of each support surface 38 interfacing with the underlying vehicle seat 11. This plane intersection location helps distribute forces acting on the support surface 38 interfacing with the vehicle seat 11 to the foot axle 34 along the plane 100 to minimize moments about the pivot axis 40.

The foot lock 36 includes a plurality of notches 37 arranged circumferentially about the foot axle 34 as shown in FIGS. 6A-6D. Each notch 37 is configured receive the foot catch 24 in the locked position when the angle-adjustment foot 32 is in a corresponding angular orientation. The foot catch 24 includes a catch protrusion 78 and a foot guide 80. The catch protrusion 78 is configured to engage with foot lock 36 of the angle-adjustment foot 32 in the locked position and is spaced apart from the foot lock 36 of the angle-adjustment foot 32 in the unlocked position. The foot guide 80 is configured to guide translation of the angle-adjustment foot 32 between the locked position and the unlocked position. The foot guide 80 has an upside-down u-shape in the illustrative embodiment. The foot lock 36 has an outer diameter or dimension to abut against the foot guide 80 in the locked position to block movement of the angle-adjustment foot 32 relative to the seat-base foundation 20 and resist forces acting between the angle-adjustment foot and the foot catch 24.

The foot axle 34 is received in an opening 22 formed in the seat-base foundation 20. The opening 22 includes a first sub-part 22A and a second sub-part 22B spaced apart from the first sub-part 22A in a vertical direction. The first sub-part 22A is configured to receive the foot axle 34 in the locked position and a second sub-part 22B is configured to receive the foot axle in the unlocked position. The pivot axis 40 is in a center of the second sub-part 22B and is spaced apart from the first sub-part 22A. The foot axle 34 is aligned with the pivot axis 40 in the unlocked position and is offset from the pivot axis 40 in the locked position.

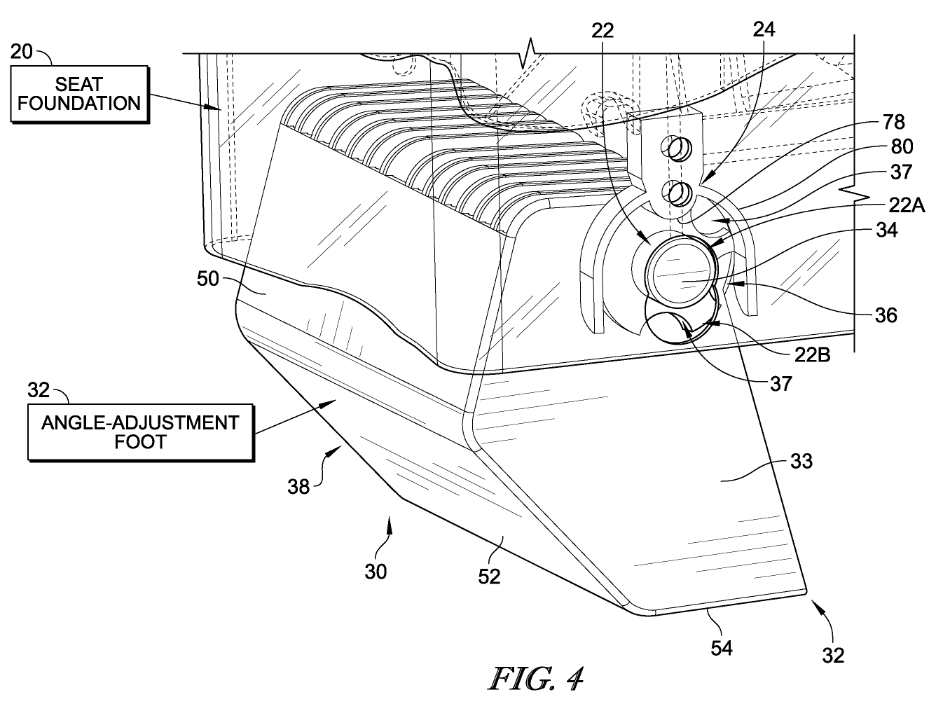

The seat base 14 includes first and second foot catches 24, 24’ as shown in FIG. 3. Each foot catch 24, 24’ is configured to engage with a corresponding foot lock 36 (only one of which is shown). The foot catch 24, 24’ may be formed integrally with the seat-base foundation 20 or separately from the seat-base foundation 20 and secured to the seat-base foundation 20 by one or more fasteners or adhesives. It is noted that the foot locks 36 are substantially similar to one another. In the illustrative embodiment, the foot axle 34 includes two separate cylindrical axel portions, each coupled to respective sides of the foot body 33 and received in respective openings 22. In other embodiments, the foot axle 34 may be a continuous rod or beam extending all the way across the foot receiving space 31 between the openings 22.

A seat base 14 in accordance with the present disclosure is shown in FIG. 1 and includes a seat-base foundation 20 and an angle-adjustment unit 30 coupled to the seat-base foundation 20. The seat-base foundation 20 is configured to support a child restraint system such as a car seat. The angle-adjustment unit 30 is configured to pivot relative to the seat-base foundation 20 such that the seat-base foundation 20 and the supported child restraint system is positioned at a desired installation angle or orientation relative to an underlying vehicle seat.

The angle-adjustment unit 30 includes an angle-adjustment foot 32, left and right foot mounts 34 (also called the foot axle 34), and left and right foot locks 36 to lock and unlock the angle-adjustment foot 32 in response to translation of the angle-adjustment foot 32 relative to the seat-base foundation 20. The angle-adjustment unit 30 is configured to provide means for adjusting the installation angle of the seat-base foundation 20 relative to the underlying vehicle seat to cause one of a plurality of support surfaces 38 established by the angle-adjustment foot 32 to engage the underlying vehicle seat in response to pivoting movement of the angle-adjustment 32 foot about a pivot axis 40 relative to the seat-base foundation 20 so that the seat-base foundation 20 establishes one of a plurality of tilted arrangements each having a different orientation relative to the underlying vehicle seat.

The angle-adjustment foot 32 includes a left and right side panel and the plurality of support surfaces 38 extending between the left and right side panels. Each of the plurality of support surfaces 38 are disposed at at an angle relative to each other. Each of the plurality of support surfaces 38 corresponds to a different installation angle or orientation of the seat-base foundation 20. The installation angle or orientation is determined by which support surface 38 contacts the underlying vehicle seat when the seat base 10 is installed. Each support surface 38 is spaced from the pivot axis 40 by a different distance to establish each installation angle or orientation depending on which surface 38 is selected to engage with the vehicle seat.

In the illustrative embodiment, the left and right foot mounts 34 of the angle-adjustment unit 30 include cylindrical pegs that extend away from the side panels of the angle-adjustment foot 32. The left and right foot mounts 34 are disposed on opposite sides of the angle-adjustment foot 32 to couple the angle-adjustment unit 30 to the seat-base foundation 20 such that the angle-adjustment foot 32 can rotate relative to the seat-base foundation 20 between the plurality of tilted arrangements, as shown in FIGS. 6A-6D.

The left and right foot locks 36 are disposed on opposite sides of the angle-adjustment foot 32, concentric with a respective corresponding foot mount 34. In the illustrative embodiment, each of the foot locks 36 is circular and shaped to form a plurality of notches 37 disposed around the circumference of foot lock 36. Each one of the notches 37 corresponds to one of the plurality of support surfaces 38 of the angle-adjustment foot 32 and a corresponding tilted arrangement of the seat-base foundation 20. The seat base may include only one foot lock 36 in some embodiments.

The seat-base foundation 20 is shaped to define a left and right foot-mount slot or opening 22 through which a corresponding one of the left and right foot mounts 34 extends to couple the angle-adjustment foot 32 with the seat-base foundation 20. The seat-base foundation 20 is further shaped to form a left and right lock protrusion 24 (also called the foot catch 24, 24’) configured to engage one of the plurality of notches 37 of a corresponding foot lock 36 of the angle-adjustment unit 30 in response to translation of the angle-adjustment foot 32 relative to the seat-base foundation 20.

Each of the foot-mount slots 22 are shaped such that the foot mounts 34 and angle-adjustment foot 32 can be pushed upwards towards the seat-base foundation 20 into a locked position or pulled downwards away from the seat-base foundation 20 into an unlocked position. In the locked position, as shown in FIGS. 2 and 4-5, one of the plurality of notches 37 of each of the foot locks 36 is pushed against the corresponding lock protrusion 24 of the seat-base foundation 20, blocking rotation of the angle-adjustment foot 32. In the unlocked position, as shown in FIG. 3, the foot locks 26 are pulled away from the lock protrusions 24 of the seat-base foundation 20, disengaging the notches 37 such that the angle-adjustment unit 30 is free to rotate relative to the seat-base foundation 20.

1. A child restraint comprising
a juvenile seat configured to support and restrain a child for transportation in a vehicle and
a seat base configured to support the juvenile seat and configured to attach to an underlying vehicle seat, the seat base including a seat-base foundation coupled to the juvenile seat, a foot catch coupled to the seat-base foundation in a fixed position relative to the seat-base foundation, and an angle-adjustment foot coupled to the seat-base foundation and movable relative to the seat-base foundation and the foot catch to adjust a tilted orientation of the seat base relative to the vehicle seat,
wherein the angle-adjustment foot is mounted to the seat-base foundation for movement relative to the seat-base foundation and the foot catch between a locked position engaged with the foot catch to block movement of the angle-adjustment foot relative to the seat-base foundation and an unlocked position at least partially separated from the foot catch to free the angle-adjustment foot for pivotable movement about a pivot axis relative to the seat-base foundation and the foot catch to a plurality of angular orientations relative to the seat-base foundation, each angular orientation corresponding with a different tilted orientation of the seat base relative to the vehicle seat.

2. The child restraint of claim 1, wherein the angle-adjustment foot includes a foot body, a foot axle extending between and interconnecting the foot body and the seat-base foundation to mount the angle-adjustment foot to the seat-base foundation, and a foot lock coupled to the foot body for movement therewith and configured to engage selectively with the foot catch in the locked position to block pivotable movement of the angle-adjustment foot about the pivot axis relative to the seat-base foundation.

3. The child restraint of claim 2, wherein the foot body includes a plurality of support surfaces each arranged along a respective plane, and each support surface is configured to interface with the underlying vehicle seat when the angle-adjustment foot is in a corresponding angular orientation.

4. The child restraint of claim 3, wherein each support surface intersects with a perpendicular plane passing through a center of the foot axle when each support surface interfaces with the underlying vehicle seat.

5. The child restraint of claim 4, wherein the perpendicular plane intersects each support surface interfacing with the underlying vehicle seat at a location between a midway point and a rearmost point of each support surface interfacing with the underlying vehicle seat.

6. The child restraint of claim 2, wherein foot body includes a first support surface configured to interface with the underlying vehicle seat when the angle-adjustment foot is in a first angular orientation to space a portion of the seat-base foundation a first distance from the underlying vehicle seat, a second support surface coupled to the first support surface and configured to interface with the underlying vehicle seat when the angle-adjustment foot is in a second angular orientation to space the portion of the seat-base foundation a second distance from the underlying vehicle seat greater than the first distance, and a third support surface coupled to the second support surface and configured to interface with the underlying vehicle seat when the angle-adjustment foot is in a third angular orientation to space the portion of the seat-base foundation a third distance from the underlying vehicle seat greater than the second distance.

7. The child restraint of claim 6, wherein the first support surface has a first length, the second support surface has a second length greater than the first length, and the third support surface has a third length less than the first and second lengths.

8. The child restraint of claim 2, wherein the foot lock includes a plurality of notches arranged circumferentially about the foot axle, and each notch is configured to receive the foot catch in the locked position when the angle-adjustment foot is in a corresponding angular orientation.

9. The child restraint of claim 2, wherein foot axle is aligned with the pivot axis in the unlocked position and is offset from the pivot axis in the locked position.

10. The child restraint of claim 2, wherein the foot axle is received in an opening formed in the seat-base foundation and the opening includes a first sub-part configured to receive the foot axle in the locked position and a second sub-part configured to receive the foot axle in the unlocked position.

11. The child restraint of claim 1, wherein the foot catch includes a catch protrusion configured to engage with the angle-adjustment foot in the locked position and spaced apart from the angle-adjustment foot in the unlocked position and a foot guide configured to guide translation of the angle-adjustment foot between the locked position and the unlocked position.

12. A seat base for a child restraint and configured to attach to a vehicle seat, the seat base comprising
a seat-base foundation,
a foot catch coupled to the seat-base foundation in a fixed position relative to the seat-base foundation, and
an angle-adjustment foot coupled to the seat-base foundation and movable relative to the seat-base foundation and the foot catch to adjust a tilted orientation of the seat base relative to the vehicle seat,
wherein the angle-adjustment foot is mounted to the seat-base foundation for movement relative to the seat-base foundation and the foot catch between a locked position engaged with the foot catch to block movement of the angle adjustment foot relative to the seat-base foundation and an unlocked position at least partially separated from the foot catch to free the angle-adjustment foot for pivotable movement about a pivot axis relative to the seat-base foundation and the foot catch to a plurality of angular orientations relative to the seat-base foundation, each angular orientation corresponding with a different tilted orientation of the seat base relative to the vehicle seat.

13. The seat base of claim 12, wherein the angle-adjustment foot includes a foot body, a foot axle extending between and interconnecting the foot body and the seat-base foundation to mount the angle-adjustment foot to the seat-base foundation, and a foot lock coupled to the foot body for movement therewith and configured to engage selectively with the foot catch in the locked position to block pivotable movement of the angle-adjustment foot about the pivot axis relative to the seat-base foundation.

14. The seat base of claim 13, wherein the foot body includes a plurality of support surfaces each arranged along a respective plane, and each support surface is configured to interface with the underlying vehicle seat when the angle-adjustment foot is in a corresponding angular orientation.

15. The seat base of claim 14, wherein each support surface intersects with a perpendicular plane passing through a center of the foot axle when each support surface interfaces with the underlying vehicle seat.

16. The seat base of claim 13, wherein foot body includes a first support surface configured to interface with the underlying vehicle seat when the angle-adjustment foot is in a first angular orientation to space a portion of the seat-base foundation a first distance from the underlying vehicle seat, a second support surface coupled to the first support surface and configured to interface with the underlying vehicle seat when the angle-adjustment foot is in a second angular orientation to space the portion of the seat-base foundation a second distance from the underlying vehicle seat greater than the first distance, and a third support surface coupled to the second support surface and configured to interface with the underlying vehicle seat when the angle-adjustment foot is in a third angular orientation to space the portion of the seat-base foundation a third distance from the underlying vehicle seat greater than the second distance.

17. The seat base of claim 16, wherein the first support surface has a first length, the second support surface has a second length greater than the first length, and the third support surface has a third length less than the first and second lengths.

18. The seat base of claim 13, wherein the foot lock includes a plurality of notches arranged circumferentially about the foot axle, and each notch is configured receive the foot catch in the locked position when the angle-adjustment foot is in a corresponding angular orientation.

19. The seat base of claim 13, wherein foot axle is aligned with the pivot axis in the unlocked position and is offset from the pivot axis in the locked position.

20. The seat base of claim 12, wherein the foot catch includes a catch protrusion configured to engage with the angle-adjustment foot in the locked position and spaced apart from the angle-adjustment foot in the unlocked position and a foot guide configured to guide translation of the angle-adjustment foot between the locked position and the unlocked position.
